(19) United States
(12) Patent Application Publication
(10) Pub. No.: US 2019/0183132 A1
(43) Pub. Date: Jun. 20, 2019

(54) Apparatus, System and Method of Manufacturing Edible, Biodegradable Containers

(71) Applicant: Cupffee Ltd., Plovdiv (BG)

(72) Inventor: Miroslav Atanasov Zapryanov, Plovdiv (BG)

(73) Assignee: Cupffee Ltd, Plovdiv (BG)

(21) Appl. No.: 16/206,576

(22) Filed: Nov. 30, 2018

(30) Foreign Application Priority Data
Dec. 18, 2017 (BG) 3934

(51) Int. Cl. A21B 7/00; A21B 5/02; A21B 1/22; A21B 3/13; A21B 3/18; A21D 13/48; B65B 65/00; B65B 25/00; B65D 65/46

(52) U.S. Cl. CPC A21B 7/005; A21B 5/02; A21B 1/22; A21B 3/13; B65D 65/463; A21D 13/48; B65B 65/003; B65B 25/001; A21B 3/18

(57) ABSTRACT

The instant invention discloses an apparatus, system and method of manufacturing edible, biodegradable containers for hot and cold beverages and food.

### FOREIGN PRIORITY CLAIM

This application claims the benefit of Bulgarian Patent Application No. 3934 (Issued Bulgarian Patent No. BG2894U1) entitled “Production Line for Edible, Biodegradable Containers for Hot and Cold Beverages and Food” invented by Miroslav Atanasov Zapryanov which was filed on Dec. 18, 2017 and published in Bulgarian Patent Bulletin No. 3.1 on Mar. 15, 2018. An English-language translation of such Bulgarian Patent is being concurrently filed herewith and is hereby incorporated by reference in this application.

### BACKGROUND OF THE INVENTION

There is a known composition for producing edible, biodegradable containers for hot and cold beverages and food. Edible, biodegradable containers for hot and cold beverages are made from a composition, which contains, in certain weight percentages, the following ingredients: oat bran, flour, sugar, gluten, margarine, alginate, stabilizer, salt, potassium sorbate, flavoring and water. The containers with the proposed composition last a long time without decomposing and disintegrating even when used to store hot drinks. An example of such known composition is disclosed in Bulgarian Patent Application No. 3057 (Issued Bulgarian Patent No. BG2170U1) entitled “Ingredients for the Production of an Edible Cup for Cold and Hot Beverages” invented by Miroslav Atanasov Zapryanov which was filed on Jul. 27, 2015 and published in Bulgarian Patent Bulletin No. 1 on Jan. 29, 2016.

The edible, biodegradable containers for hot and cold beverages and food are handmade with a very low degree of automation. The manual production of these containers, which includes a number of operations such as kneading, molding and baking, etc., is a difficult and prolonged process with low productivity.

There is no known apparatus, system or method for the production of edible, biodegradable hot and cold beverages and food containers to automate the process and increase productivity to meet market needs.

### SUMMARY OF THE INVENTION

The instant application is directed towards to an apparatus, system and method of manufacturing edible, biodegradable containers for hot and cold beverages and food.

The instant application discloses:
(i) an apparatus for manufacturing edible, biodegradable containers for hot and cold beverages and food;
(ii) a system for manufacturing edible, biodegradable containers for hot and cold beverages and food; and
(iii) a method of manufacturing edible, biodegradable containers for hot and cold beverages and food;
   which increases labor productivity and automates the manufacturing process.

This objective is accomplished by an apparatus, system and method of manufacturing edible, biodegradable containers for hot and cold beverages and food, which consists of a control unit connected to a sequentially installed kneading machine, dosing machine, forming and baking machine, cooling tunnel, labeling machine and packaging machine, all of which are connected by a conveyor belt.

The forming and baking machine is comprised of at least one forming unit, which includes one or more forming sockets. Each forming socket consists of a body in which: (i) in certain embodiments, a demountable mold; or (ii) in certain embodiments, a non-removable mold; is affixed. In certain embodiments, such mold has a heater while in certain other embodiments, such mold does not have a heater (i.e., where there is gas heating). A punch is movably positioned in the mold, whereby a gap with a preselected width is formed between the mold and the punch. In embodiments utilizing electrical heating, a heater is installed in the punch cavity. In embodiments utilizing gas heating, a cavity is not needed.

The punch ends with a flange located outside of the forming socket, with openings predrilled on the periphery of the flange. Around the punch, beneath the flange, an unloading element having the shape of a washer is movably positioned, with openings predrilled at its periphery, coinciding with the openings on the flange. Linear guides are mounted in the peripheral openings of the flange and the unloading element. In the case where the body 11 is made of two or more parts this unloading element 15 is not necessary.

In one embodiment, the mold is in the form of a concave inverted cone whose outer surface forms the outer surface of the edible container. In one embodiment, such a mold could be further provided with vertical air and water vapor discharge grooves.

In one embodiment the punch is also in the form of an inverted truncated cone. In one embodiment, the punch also has on its sides longitudinal air and water discharge grooves formed in the mold-forming process of the containers. On the outer surface of the punch, there are cylindrical retaining grooves, perpendicular to the longitudinal grooves.

According to one embodiment, vertical grooves are provided on the inner surface of the unloading element, and radial grooves connected to the vertical ones are made on its upper plane.

According to another embodiment, the forming unit is constituted by a multitude of forming sockets, which are grouped in a common unit, the flanges of the punches being joined together in a common upper plate and the unloading elements in a common movable unloading plate, in which case the system is provided with locking mechanism.

One advantage of the instant invention is that the process of manufacturing edible, biodegradable containers is automated, which increases productivity and reduces the cost per unit of production.

### BRIEF DESCRIPTION OF THE DRAWINGS

FIG. 1 is a block diagram of the system for manufacturing edible, biodegradable containers for hot and cold beverages and food.

FIG. 2 is an axonometric view of a forming unit.

FIG. 3 is a first axonometric view of a forming socket.

FIG. 4 is a second axonometric view of a forming socket.

FIG. 5 is an axonometric view of a punch.

FIG. 6 is an axonometric view of the unloading element, which removes the finished container.

### REFERENCE NUMERALS

1. Kneading Machine
2. Dosing Machine
3. Forming and Baking Machine
4. Cooling Tunnel
5. Labeling Machine
6. Packaging Machine
7. Conveyor Belts
8. Control Unit
9. Forming Unit
10. Forming Socket
11. Body
12. Demountable Mold
13. Upper shape-forming body (punch)
14. Flange
15. Unloading Element
16. Heater
17. Fine Grooves
18. Outer Surface Longitudinal Grooves
19. Concentric Cylindrical Retaining Grooves
20. Vertical Grooves
21. Radial Grooves
22. Carrier Plate
23. Upper Plate
24. Movable Unloading Plate
25. Locking Mechanism
26. Cylindrical Openings
27. Cylindrical Openings

### DETAILED DESCRIPTION OF THE INVENTION

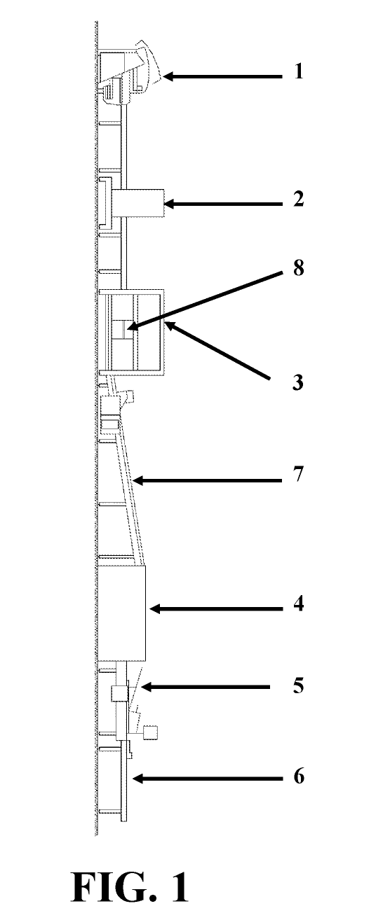

An example of the embodiment of an apparatus, system and method of manufacturing edible, biodegradable containers for hot and cold beverages and food is shown in FIG. 1. This apparatus, system and method of manufacturing edible, biodegradable containers is, in particular, adapted for the production of containers for coffee.

The system of manufacturing edible, biodegradable containers for hot and cold beverages and food consists of sequentially installed kneading machine 1, a dosing machine 2, a forming and baking machine 3, a cooling tunnel 4, a labeling machine 5 and a packaging machine 6. Conveyor belts 7 are installed between the individual units of the system to transport the produce. The composite parts of the system are also connected to a control unit 8, by means of which adjustment, coordination and automation of the production processes are achieved.

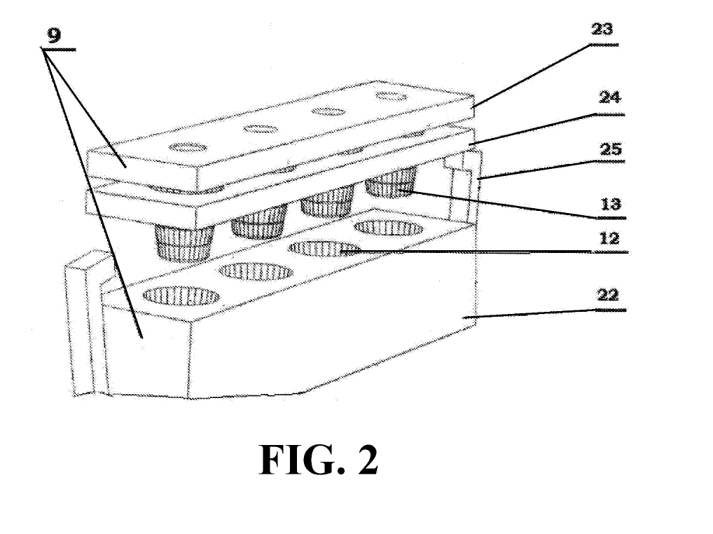

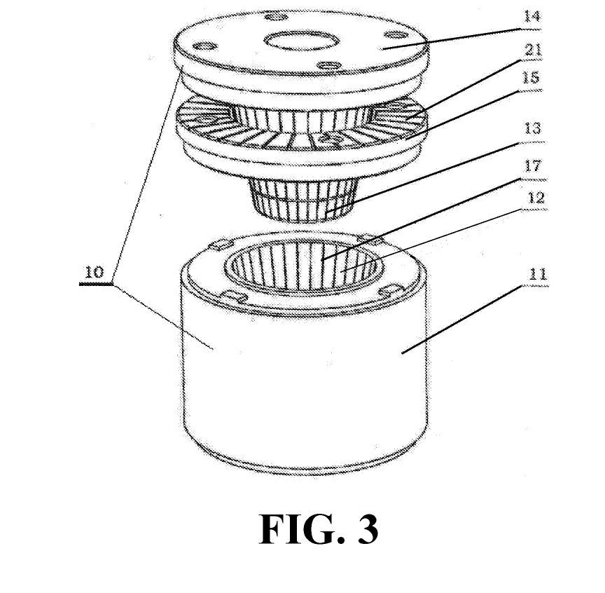

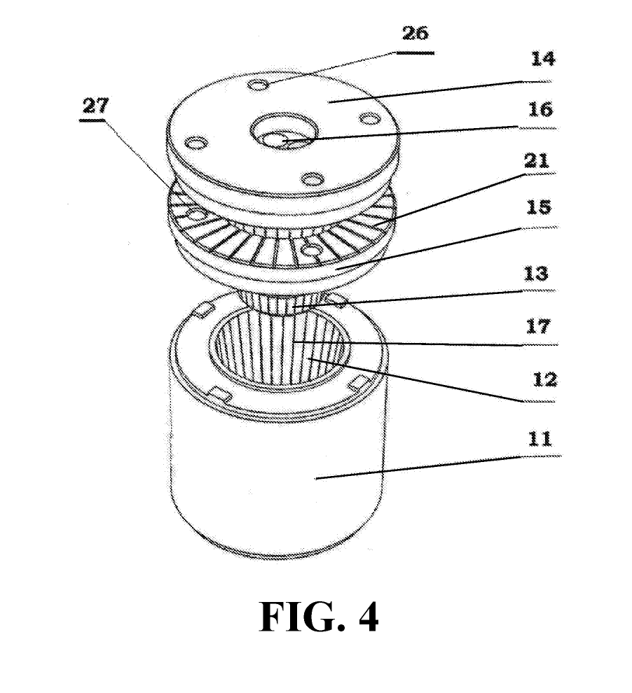

The main and most important unit of the system is the forming and baking machine 3, i.e., the apparatus for manufacturing edible, biodegradable containers for hot and cold beverages and food, which consists of at least one forming unit 9 as shown in FIG. 2. In turn, each forming unit 9 is constituted by at least one forming socket 10 as shown in FIG. 3 and FIG. 4.

The forming sockets 10 may be of any shape. For example, the forming sockets 10 may imitate a coffee cup, tea cup, soup bowl, etc. In the embodiment shown in the drawings, an example of a coffee cup forming socket 10 is given.

In the embodiment shown in the drawings, each forming socket 10 is formed by a body 11 in which a demountable mold 12 is affixed. Alternatively, as not pictured in the drawings, the mold 12 could be non-removable and carved directly in the body 11. The body 11 can be made up of one, two, or more than two opening parts. An upper shape-forming body (i.e., a “punch”) 13 is movably positioned in the demountable mold 12.

The punch 13 ends with a flange 14 whose periphery has cylindrical openings 26. Around the punch 13, beneath the flange 14, an unloading element 15 having the shape of a washer is movably positioned, with openings 27 predrilled at its periphery. The unloading element 15 is used to remove the already baked container from the punch 13. In the case where the body 11 is made of two or more parts, this unloading element 15 is not necessary.

In the cylindrical openings 26 of the flange 14 and in the cylindrical openings 27 of the unloading element 15 are mounted linear guides (not shown in the figures) which provide the linear movement of the unloading element 15 relative to the punch 13.

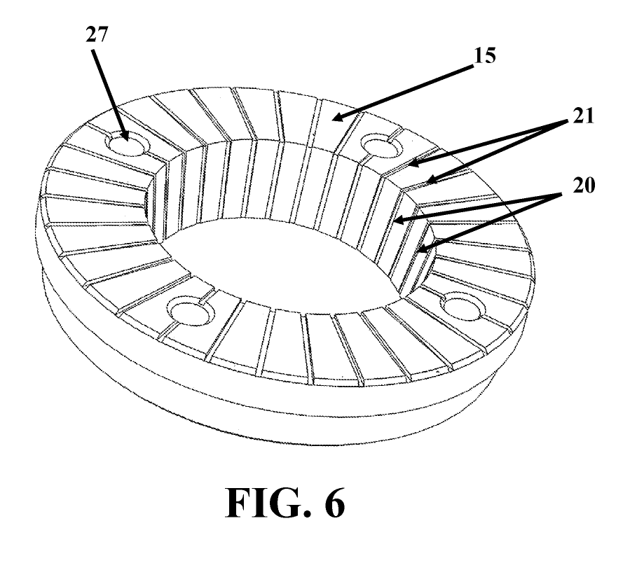

On the inner surface of the unloading element 15 there are fine longitudinal grooves as in FIG. 6.

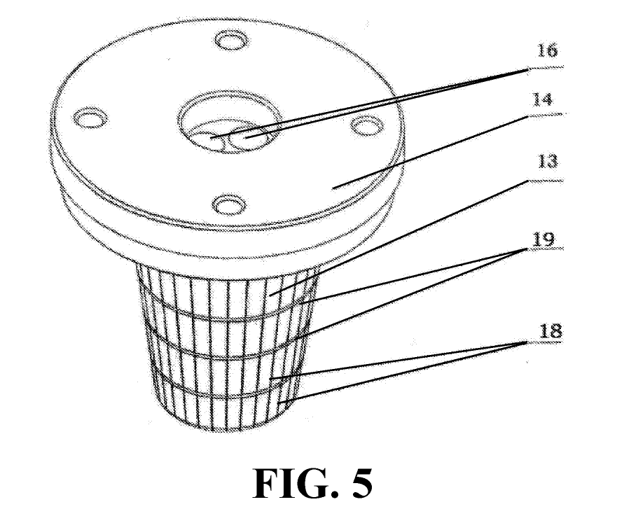

In the central portion of the punch 13, along its inner cavity, at least one heater 16 is provided for the baking of the edible container (e.g., a coffee cup) as shown in FIG. 4 and FIG. 5 in the electrical heating embodiment shown in drawings. In embodiments having gas heating (not shown in the drawings), a cavity is not necessary.

As noted above, the mold 12 (which is shown in the drawings as having the shape of an inverted truncated cone) is mounted in the body 11. The mold 12 forms the outer surface of the edible container. In certain embodiments, the mold 12 can be provided with fine grooves 17, most often vertical along the inner surface of the mold 12. In other embodiments (not shown in the drawings), the mold 12 can be provided without fine grooves 17. The grooves 17 serve to remove air and water vapor that are produced during the forming and baking process of the container. In the body 11, heaters are mounted near the mold 12 for the baking of the edible container in certain embodiments. These heaters are not shown in the attached figures. In other embodiments (e.g., in the case of gas heating), there are no such heaters.

In certain embodiments, the punch 13 is also in the form of an inverted truncated cone, having on its outer surface longitudinal grooves 18, which function to discharge the air and water produced in the container forming process. In other embodiments, the punch 13 does not have such longitudinal grooves 18. On the outer surface of the punch 13, there are also concentric cylindrical retaining grooves 19, perpendicular to the longitudinal grooves 18. The retaining grooves 19 ensure that the finished container (e.g., the ready coffee cup) remains fixed to the punch 13. In the case where the body 11 is made of two or more opening parts and there is no unloading element 15, such retaining grooves 19 are not necessary.

On the inner surface of the unloading element 15, vertical grooves 20 are provided for the discharge of air and water vapor formed in the container forming process. On the upper plane of the unloading element 15, radial grooves 21 are provided which are connected to the vertical ones 20.

In one embodiment, each forming unit 9 may have a plurality of forming sockets 10 of different number, type and shape, which when actuated form separate containers of the same or different shape depending on the forming sockets used as shown in FIG. 2.

In certain embodiments, several forming sockets 10 are joined together in a common forming unit 9 then the bodies 11 may be separated from one another while being grouped together in a common carrier plate 22. This also means that the cylindrical parts of the sockets 10 (i.e., the flanges 14 of the punches 13) are joined together in a common upper plate 23, and the unloading elements 15 are joined in a common movable unloading plate 24. In such embodiments where the carrier plate 22 is made of two or more parts, the unloading plate 24 is not necessary.

In this case, the system is provided with a locking mechanism 25 which functions to ensure that the upper plate 23 remains stationary relative to the carrier plate 22 during the baking process. In the embodiment shown in the drawings, such locking mechanism 25 is shown as a “clamp,” but the locking mechanism 25 could consist of any similar means for locking known in the art (and the selection of such mechanism could depend on the number of sockets 10).

All elements of the forming and baking machine 3 are made of metal suitable for food contact—for example, aluminum, stainless steel, cast iron or others, which possess the required qualities.

The method of manufacturing the containers consists of the following steps in sequence:
1. mixing of the ingredients necessary for the production of the edible containers to create a dough;
2. kneading said dough;
3. dosing said dough (i.e., apportioning the proper amount of dough);
4. forming and baking of the edible containers;
5. cooling of the products;
6. (optionally) labeling; and
7. (optionally) packaging the finished containers.

An example of the composition for the production of edible, biodegradable hot and cold beverage and food containers includes (by percent weight): oat bran—24%; flour—20.5%; sugar—8.2%; gluten—5.7%; margarine—8.2%; alginate—0.82%; xanthan gum—0.82%; salt—0.41%; potassium sorbate—0.82%; flavoring—1.23%—with the remainder consisting of water.

The weighing and portioning of the individual components may be accomplished by using a balance and standardized containers designed and meeting the requirements of the food industry. After this, the dry products (e.g., flour, oat bran, dry gluten, sugar, salt and alginate) are weighed and then mixed. Next comes the addition of the water, margarine and flavoring. Then follows a process of mixing of the ingredients, which is carried out using the kneading machine 1 (e.g., a dough mixer) as shown in FIG. 1.

After kneading and resting, the dough, via the conveyor belt 7, is fed to a collecting hopper of a dosing machine 2 (shown in FIG. 1 but not shown in the accompanying figures). The dough is divided into precise doses, each with a weight corresponding to the weight of the container to be manufactured (e.g., containers for coffee).

The dough already dosed is placed in the sockets of the forming and baking machine 3. In certain embodiments, the forming and baking machine 3 can be provided with a hydraulic or pneumatic press (not shown in the figures). The forming and baking machine 3 also has the necessary sockets 10 in which the containers are formed. The forming unit 9 itself may contain sockets 10 of a different number, type and shape, thus forming the individual containers.

Then each dose of dough is molded by pressing each pre-heated punch 13 to its respective heated mold 12.

The baking of the dough, after molding it between the two parts of the socket, is carried out at a baking temperature between 150° C. and 180° C. for a certain period. For this purpose, the mold 12 and the punch 13 are constantly heated, while temperature controllers are responsible to maintain the desired exact temperature.

The baking time is in direct dependency on the baking temperature, on the container size and thickness, and the desired degree of doneness. Normally, the baking time is approximately 2 to 2.5 minutes.

By closing the individual parts of the forming unit 9 by means of the locking mechanism 25 and starting to bake the dough, water starts to evaporate (i.e., the water in the dough is evaporated). This, in turn, leads to an increase in pressure inside the molds 12. Pressure is desirable to achieve good homogeneity and density of the container, but pressure values greater than desired can lead to an explosion. In certain embodiments, excessive pressure is prevented by means of air and vapor grooves (for example as shown in 17, 18, 20 and 21) and openings, thus controlling the pressure value. In practice, the process for making the wafer containers (e.g., containers for coffee) may be thought of as “baking under pressure.”

As noted, the heating of the forming sockets 10 and the punches 13 is achieved by means of coiled heating elements, but can also be achieved in other ways, for example by gas or by preheated fluid circulating through the mold.

The unloading element 15, or, respectively, the common unloading plate 24, is designed to “push” the finished container(s) from the punch 13. This happens as the movement of the unloading element 15, or of the unloading plate 24, respectively, is limited a few moments before the press stops its opening movement, after baking is complete. The unloading element 15 may also be in the form of separate rings, a separate element, or embedded in the punch.

In order to increase the range of input materials in the forming and baking machine 3, a space for forming a molding flash may be provided in the mold 12. This space is at the top of the mold 12 and is intended to provide smooth balancing of the pressure inside the mold 12. Due to this balancing, it is possible for the excess material to exit smoothly.

The resulting container is then cooled to room temperature in the cooling tunnel 4 and is transported for labeling and packaging in the machines for labeling 5 and packaging 6.

Optionally, a complementary element may be attached to the container thus obtained. For example, a label, which is an arc-shaped adhesive tape with a folding handle may be attached to the manufactured containers.

In an alternative embodiment, the container of this composition, for the convenience of the user, may be produced with a handle of the same dough.

The entire production process of the system is coordinated, adjusted and automated by the control unit 8.

A container thus prepared is a slightly hygroscopic, edible wafer (biscuit) container, i.e., a cup or bowl. It is designed for serving hot and cold liquids such as soups, coffee, cappuccino, hot chocolate, hot and cold milk and other food and beverages. The container thus prepared can be consumed, for example, after drinking the beverage.

The container thus created, if disposed of in the environment, rather than being eaten, is ecologically safe and 100% biodegradable in a short time.

The invention claimed is:

1. a system of manufacturing edible, biodegradable containers for hot and cold beverages and food comprising:
(i) a control unit;
(ii) a kneading machine;
(iii) a dosing machine; and
(iv) a forming and baking machine further comprising:
(a) at least one forming unit, said forming unit comprising at least one forming socket; and
(b) at least one heating source;
wherein said kneading machine, dosing machine and forming and backing machine are connected by at least one conveyor belt.

2. the system of claim 1 wherein each forming socket further comprises:
(i) a mold;
(ii) a punch; and
(iii) an unloading element.

3. the system of claim 1 wherein each forming socket further comprises:
(iv) a body, said body having a mold;
(v) a punch; and
(vi) an unloading element.

4. the system of claim 3 wherein said mold is a demountable mold.

5. the system of claim 1 wherein said punch has an internal cavity; said at least one heating source comprising an electrical heater located within said internal cavity of said punch.

6. the system of claim 1 further comprising:
(v) a cooling tunnel;
(vi) a labeling machine; and
(vii) a packaging machine;
wherein said kneading machine, dosing machine, forming and backing machine, cooling tunnel, labeling machine and packaging machine are connected by at least one conveyor belt.

7. a method of manufacturing edible, biodegradable containers for hot and cold beverages and food comprising:
(i) kneading dough;
(ii) dosing said dough based on the desired dimensions of said container;
(iii) forming and baking said container, said forming and baking further comprising:
(a) depositing said dough into a mold;
(b) compression molding said dough by inserting a punch into said mold;
(c) heating said mold and said punch to a baking temperature of between 150° C. and 180° C. for approximately 2 to 2.5 minutes to bake said dough until said dough reaches a desired degree of doneness;
(d) removing said punch from said mold; and
(e) ejecting said container from said mold using an unloading element; and
(iv) cooling said container.

8. the method of claim 7 further comprising:
(i) an intermediate step between steps (i) and (ii) whereby said kneaded dough is transported to a dosing machine by means of a conveyor belt;
(ii) an intermediate step between steps (ii) and (iii) whereby said dosed dough is transported to a forming and baking machine by means of a conveyor belt;
(iii) an intermediate step between steps (iii) and (iv) whereby said container is transported from the forming and baking to a cooling tunnel by means of a conveyor belt; and
(iv) cooling said container by means of said cooling tunnel.

9. an apparatus for manufacturing edible, biodegradable containers for hot and cold beverages and food comprising:
(i) at least one forming unit, each forming unit further comprising at least one forming socket with each forming socket further comprising:
(a) a body, said body having a mold;
(b) a punch; and
(c) an unloading element;
and
(ii) at least one heating source.

10. the apparatus of claim 9 wherein said mold, punch and unloading element all have air and water vapor discharge grooves.

11. the apparatus of claim 9 wherein:
(i) said body has a first internal cavity;
(ii) said punch has a second internal cavity; and
(iii) said at least one heating source further comprises:
(a) a first electrical heater located within said first internal cavity of said body; and
(b) a first electrical heater located within said second internal cavity of said punch.

12. the apparatus of claim 9 wherein said mold is demountable from the body.

13. the apparatus of claim 9 wherein:
(i) said punch is dimensionally sized to telescopingly extend into the mold;
(ii) said punch has a flange extending outwardly from the mold with a plurality of flange openings on the periphery of the flange;
(iii) said unloading element having a periphery with a plurality of unloading element openings at said periphery; and
(iv) a plurality of linear guides, each of said linear guides dimensionally sized to pass through one flange opening and one unloading element opening.

14. the apparatus of claim 13 wherein said mold is demountable from the body.

15. the apparatus of claim 9 wherein said mold has an outer surface and is in the form of a concave inverted cone, said outer surface of said mold further having a plurality of longitudinal grooves.

16. the apparatus of claim 9 wherein said punch has an outer surface and is in the form of an inverted truncated cone, said outer surface of said punch further having a plurality of longitudinal grooves and a plurality of concentric cylindrical retaining grooves perpendicular to said longitudinal grooves.

17. the apparatus of claim 9 wherein:
(i) said mold has an outer mold surface and is in the form of a concave inverted cone, said outer mold surface further having a plurality of longitudinal grooves; and
(ii) said punch has an outer punch surface and is in the form of an inverted truncated cone, said outer punch surface further having a plurality of longitudinal grooves and a plurality of concentric cylindrical retaining grooves perpendicular to said longitudinal grooves.

18. the apparatus of claim 9 wherein said unloading element has:
(i) an inner service having a plurality of vertical channels;
(ii) an upper plane having a plurality of vertical grooves extending towards an outer edge of said upper plane; and
(iii) each of said vertical channels connected to at least one vertical groove.

19. the apparatus of claim 9 wherein said forming unit further comprises a plurality of forming sockets wherein:
(i) each punch is united in a common upper plate; and
(ii) each unloading element is united in a common unloading plate.

20. the apparatus of claim 17 wherein said body is a common carrier plate.
